(19) United States
(12) Patent Application Publication
(10) Pub. No.: US 2006/0038745 A1
(43) Pub. Date: Feb. 23, 2006

(54) Variable stiffness screen

(76) Inventors: Alex Naksen, Flushing, NY (US); Dennis Naksen, Flushing, NY (US)

Correspondence Address: Mr. Alex Naksen, Apt. 2H, 142-15 26th Avenue, Flushing, NY, 11354, US

(21) Appl. No.: 10/921,601

(22) Filed: Aug. 19, 2004

(51) Int. Cl. G09G 3/00

(52) U.S. Cl. 345/30; 257/40

(57) ABSTRACT

A variable stiffness screen for wearable electronic devices provides a viewable area that can be adjusted by managing the screen's physical properties. The screen incorporates a flexible electronic display, attached to a structural system, in which the physical properties can be changed from a flexible state to a rigid one to control the stiffness of the display.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER PROGRAM LISTING COMPACT DISC APPENDIX

### BACKGROUND OF THE INVENTION

This invention relates to a display unit and, in particular, to a display unit using a flexible medium, which can be rolled up or folded for compact storage and used in conjunction with electronic communication and processing devices.

Our lives are pervaded by a myriad of various kinds of portable and wearable digital devices, many of which are necessary to operate and used on a daily basis. Being used mostly on the go they have some inherent difficulties not allowing for their operation in a precise, quick and comfortable manner. There is an intrinsic contradiction between the miniaturization of wearable electronic devices accompanied by the increasing flow of visual information and the practically unchanged human abilities to receive this information by eye. Reading anything more than a headline on a screen that is barely larger than an inch square is a rather challenging task for our vision. On the other hand, the pocket computer/PDAs are equipped with rather readable displays, but their sheer bulk and rigid shape become insuperable obstacles in situations when size and a way of carrying matter.

It may become the main hurdle not allowing the full realization of the immensely potent high-speed “third generation”, or 3G, cellular systems. In our view, the screen size is a critical factor defining the user's experience in this area of mobile computing and communication. We think there is a better way to deliver visual information without either hurting our vision or making the device uncomfortably bulky and heavy. To satisfy the user's needs, an electronic display has to be big enough to display the necessary amount of information in a way comfortable for the eyes, and, at the same time, it has to be unobtrusively small, when the user doesn't need it

An attempt to solve this problem based on the conventional solid LCD technology, is presented in U.S. Pat. No. 6,144,550 to Weber et al, which disclosed an inflatable and collapsible segmented screen for portable computers, TV screens and the like. The proposed way to fold the screen is to make it from a few rigid segments connected to each other, and supported by some inflated envelopes placed behind the screen. Some important aspects of the screen's functioning, including the processes of inflating, deflating and folding are not resolved in this patent, hence making it dependent on some external help.

The currently developing ultra-thin flexible electronic display film technology is the most promising in terms of complying with the requirements of portability and comfort of usage. The flexible display can be of various designs and technological features including OLED, LEP, E-Ink, Flexible LCD and so forth. For instance, the OLED display (Organic or polymer light-emitting diodes) provides a high degree of brightness and a wide viewing angle while consuming less energy than common LCD displays. It is thin (1.5 mm-2.0 mm) and, when organic compound is applied to a flexible insulated substrate (plastic, for instance), the entire screen can be bent without loosing its properties. U.S. Pat. No. 5,821,688 to Shanks, et al., which is herein incorporated by reference, discloses a flexible panel display having thin film transistors driving polymer lightemitting diodes.

The mobile communication device, which is built around a flexible display, is disclosed in U.S. Pat. No. 6,311,076 B1 to Peuhu et al. The display is movable between a retracted position within the cylindrical housing to an in-use (withdrawn) position where the display is visible to the user. In the withdrawn mode the flexible display is supported by an antenna in its unfolded position, that is extended perpendicularly to the device's housing. This approach to support the flexible display limits the way of holding the device to virtually only one position, when the device is vertically oriented with a horizontally withdrawn display. In any other position the screen's planar geometry, being supported only partially, would be seriously impaired, making displayed information rather unreadable. Secondly, it requires a few separate moves for making this system work, including withdrawal of the display, unfolding of the antenna and snapping of the display to it.

Summarizing, the important problems associated with either rollable or foldable electronic screen displays can be identified as follows:
a) Miniaturization of wearable electronic devices is limited by the size of an electronic display, which has to be large enough to provide readable visual information. A technologically achievable much greater volume of visual information is also limited by the display size. The great potential of 3G cellular systems could not be fully realized, due to the relatively small conventional LCD display. The apparent limitation of the display size is the device's body itself.
b) Implementation of flexible display technology could solve the aforementioned problem. To achieve it, an electronic screen has to be used at least in two working modes. Firstly it has to be rolled or folded for compact storage, thus reducing the overall size of a particular electronic device. Secondly, it has to be fully opened to display the amount of information associated with either Internet content or a PDA function. At the same time, the virtue of flexibility, which allows for changing of the display's geometry, becomes a liability, when the flexible screen is in a withdrawn position. In this position the flexible display is structurally unstable, not allowing for reading of the displayed information in a quick, precise and comfortable manner.
c) Therefore the flexible display in its withdrawn position needs to be supported in some suitable way. An external support in the form of a rod-like element, an antenna, for instance, limits the user's options of holding the device to only one particular three-dimensional position. It substantially decreases the whole value of a flexible screen as a universally used medium.
d) The process of pulling the display out and making it functional in the withdrawn mode comprises a few separate moves. It makes this process unnecessarily cumbersome, especially when one needs to respond to an incoming call.
e) When a foldable screen is supposed to be supported internally, for instance by inflating a structure bonded to the screen, the absence of a built-in actuation means (pumps, valves and so forth) renders the entire system quite inefficient, always dependent on some external help.

### BRIEF SUMMARY OF THE INVENTION

Accordingly, it is an object of this invention to solve the problems created by the miniaturization of wearable electronic devices accompanied by the increasing flow of visual information, while the human abilities to receive this information by eye remain practically unchanged. More specifically, it is an object of the present invention to provide a lightweight screen display with a viewable area that can be adjusted depending on the volume of information and, ultimately, on the user's needs.

The variable stiffness screen of this invention makes it possible to change the display size by managing the display's stiffness. In all of the embodiments the variable stiffness screen incorporates a flexible display attached to a certain structural support system. The screen can be encased in a carrying member, either a flexible sleeve or a rigid cartridge. Also the screen can be installed directly into a particular electronic device.

The main element of the proposed invention is a structural system allowing for changing of the screen's stiffness. The screen's support system in all of its embodiments allows the flexible display to be normally pliable and placed inside the carrying member and, when it is actuated, to be firm and rigid for having a standout working position. The system functions in five preferred embodiments, varying in specific means of supporting the screen.

Firstly, the structural transition from flexibility to rigidity is achieved by managing the volume, and respectively, the pressure of certain fluids coming into the hermetically sealed chambers having substantially flexible, resilient walls. This group consists of three fluid-based embodiments, which are: pneumatic support system, hydraulic support system, and hydropneumatic support system. In all the cases, when the system is activated, the fluid comes into structurally arranged conduits behind the display's surface, thus making it firm and stable. To make the screen pliable the fluid's pressure in conduits is reduced to the necessary level.

Secondly, the desirable transformation of the screen's structural properties is achieved by changing the geometry of the supporting members, steel ribbon for instance, from an arcuate cross-section configuration to a flat one. This constitutes an alternative linear support system.

Thirdly, employing Shape Memory Alloys (SMA) for supporting elements achieves the necessary transfer from the flexible to stiff. The proposed second alternative (superelastic) support system is based on the ability of SMAs to change their physical properties from the flexible to rigid when heated.

Therefore, several objects and advantages of the present invention are:
a) The variable stiffness screen provides an electronic device with a display that can be much bigger than the device itself Miniaturization of wearable electronic devices is no longer limited by the size of a built-in electronic display. A relatively small electronic device such as a multifunctional electronic watch could incorporate a screen of this invention, allowing for displaying of Internet pages and multimedia applications in a way comfortable for the eyes.
b) The design of the variable stiffness screen allows combining of two seemingly contradictory features, which an electronic screen, based on the flexible display technology, should possess. The first one is firmness or structural stability for displaying of information and being able to be used as a touch screen. The second one is sufficient flexibility for it to be rolled up or folded for compact storage.
c) The screen's integrally built support system makes the display usable in any three-dimensional position in which the user can put it. A flexible display can be used as a universal medium for the whole plethora of cellular phones, multifunctional electronic watches and the like. The user can hold them in any convenient manner according to personal habits and wishes.
d) The process of pulling the display out and making it functional in the withdrawn mode is very simple, consisting of only a single move accompanied by the system's simultaneous actuation. One move operation provides the display with the desirable immediate accessibility to information.
e) The screen's support system includes all the necessary structural and actuation means, making the screen independent from outer sources and self-sufficient in various conditions.
d) The screen's support system is adjustable to a variety of structural features of currently being developed flexible displays. The display's minimal thickness, as well as its stiffness, can vary depending on a particular flexible display technology implementation.

Further objects and advantages will become apparent from a consideration of the ensuing description and drawings.

### BRIEF DESCRIPTION OF THE SEVERAL VIEWS OF THE DRAWING DRAWING FIGURES

The invention will be more readily understood with reference to the accompanying drawings, wherein:

FIG. 1 shows an overall perspective view of a variable stiffness screen encased in a flexible sleeve according to the first preferred embodiment of the present invention.

FIG. 2 shows an overall perspective view of a variable stiffness screen encased in a rigid case according to the second preferred embodiment of the present invention.

FIG. 3 shows an exploded perspective view of a variable stiffness screen of FIG. 1.

FIG. 4 shows a rear view of a variable stiffness screen of FIG. 1 with a broken out portion of the sleeve.

FIG. 5 shows a sectional view taken along section line 5-5 of FIG. 4.

FIG. 6 shows a rear view of a variable stiffness screen of FIG. 2 with a broken out portion of the case.

FIG. 7 shows a sectional view taken along section line 7-7 of FIG. 6.

FIG. 8A shows a sectional view of the winding mechanism, when the detent is positioned at the right end of the drum's threaded shaft, next to the right support.

FIG. 8B shows an enlarged sectional view of the winding mechanism, when the detent engages the corresponding depression in the drum.

FIG. 8C shows an enlarged sectional view of the winding mechanism, when the slide-button is pushed to disengage the detent

FIG. 9 shows an enlarged sectional view taken along section line 9-9 of FIG. 8B.

FIG. 10 shows an enlarged right upper part of FIG. 4 with a broken out portion of the handle.

FIG. 11 shows an enlarged left upper part of FIG. 4 with a broken out portion of the handle.

FIG. 12 shows an enlarged sectional view taken along section line 12-12 of FIG. 4.

FIG. 13 shows an enlarged sectional view taken along section line 13-13 of FIG. 11.

FIG. 14 shows the conduits configuration with one central vertical element.

FIG. 15 shows the conduits configuration with one central vertical element and two peripheral vertical elements.

FIG. 16 shows a wafer-like configuration of the conduits.

FIG. 17 shows a honey comb-like configuration of the conduits.

FIG. 18 shows the rear view of an additional embodiment of the variable stiffness screen with a broken out portion of the sleeve.

FIG. 19 shows an enlarged sectional view taken along section line 19-19 of FIG. 18.

FIG. 20 shows an enlarged sectional view taken along section line 20-20 of FIG. 18.

FIG. 21 shows the rear view of a second additional embodiment of the variable stiffness screen with a broken out portion of the sleeve.

FIGS. 22A and 22B show an enlarged sectional view taken along section line 22-22 of FIG. 21 before air pressure is applied to the membrane and after it

FIG. 23 shows the front view of an alternative embodiment of variable stiffness screen with a broken out portion of the sleeve.

FIG. 24 shows a sectional view taken along section line 24 of FIG. 23.

FIG. 25 shows an enlarged sectional view taken along section line 25-25 of FIG. 23.

FIG. 26 shows an enlarged sectional view taken along section line 26-26 of FIG. 23.

FIG. 27 shows an enlarged sectional view taken along section line 27-27 of FIG. 23.

FIG. 28 shows the front view of a second alternative embodiment of the variable stiffness screen with a broken out portion of the sleeve.

FIG. 29 shows a sectional view taken along section line 29-29 of FIG. 28.

FIG. 30 shows an enlarged sectional view taken along section line 30-30 of FIG. 28.

FIG. 31 shows a schematic diagram of electrical circuitry.

### REFERENCE NUMERAL IN DRAWINGS

1 variable stiffness screen with pneumatic support system

| | |
|---|---|
| 10 flexible display | |
| 20 flat sleeve | 21 sleeve's opening |
| 30 case | 31 case's opening |
| | 32 flat part of the case |
| | 33 cylindrical enclosure of the |
| | case |
| 40 winding mechanism | 41 cylindrical drum |
| | 42 extended cylindrical drum |
| | 43 coil spring |
| | 44 left support |
| | 45 right support |
| | 46-ribbon cable |
| | 47 guide member |
| 50 latch mechanism | 51 detent |
| | 52 slide |
| 100 pneumatic support system | |
| 110 air inflatable portion | 112 inner sheet |
| | 113 groove |
| | 114 outer sheet |
| | 116 conduits |
| 120 handle | 121 intake tube |
| | 122 intake check valve |
| | 123 adaptor |
| | 124 air pump |
| | 125 adaptor |
| | 126 outlet check valve |
| | 128 connecting tube |
| 130 release valve | 132 plunger |
| | 133 coil spring |
| | 134 fitting |
| | 135 aperture |

2 variable stiffness screen with hydraulic support system

| | |
|---|---|
| 200 hydraulic support system | |
| 210 flexible portion | 212 inner sheet |
| | 213 groove |
| | 214 outer sheet |
| | 216 supporting conduits |
| 220 handle | 221 outlet check valve |
| | 222 ball |
| | 223 coil spring |
| | 224 hydraulic bulb pump |
| | 225 outlet check valve |
| | 226 ball |
| | 227 coil spring |
| | 228 hydraulic fluid tank |
| | 230 drain valve |

3 variable stiffness screen with hydropneumatic support system

| | |
|---|---|
| 300 hydropneuniatic support system | |
| 310 conduits | |
| 320 handle | 322 air pump |
| | 324 intake check valve |
| | 326 outlet check valve |
| | 328 release valve |
| 330 hydropneumatic tank | 332 rigid shell |
| | 334 flexible bladder |
| | 336 orifice |

4 variable stiffness screen with linear support system

| | |
|---|---|
| 400 linear support system | |
| 22 flat sleeve | |
| 410 left linear member | 412 right linear member |
| 414 bracket | |
| 420 handle | |
| 430 left upper gate | 432 right upper gate |
| 440 left middle gate | 442 right middle gate |
| 450 left lower gate | 452 right lower gate |

5 variable stiffness screen with superelastic support system

| | |
|---|---|
| 500 superelastic support system | 502 bracket |
| 510 core wire | 512 polyimide coating |
| | 514 foamed silicon |
| | 516 tubular sleeve |
| 520 handle | |
| 530 temperature monitor | |
| 540 power supply | 542 switch |

### DETAILED DESCRIPTION OF THE INVENTION

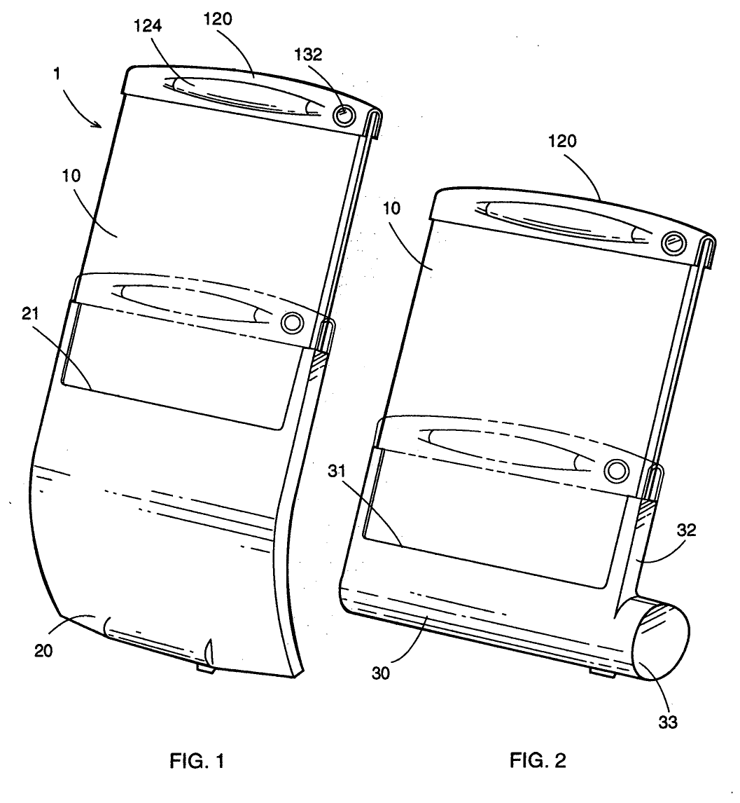

### Preferred Embodiment: Variable Stiffness Screen with Pneumatic Support System, FIGS. 1-17

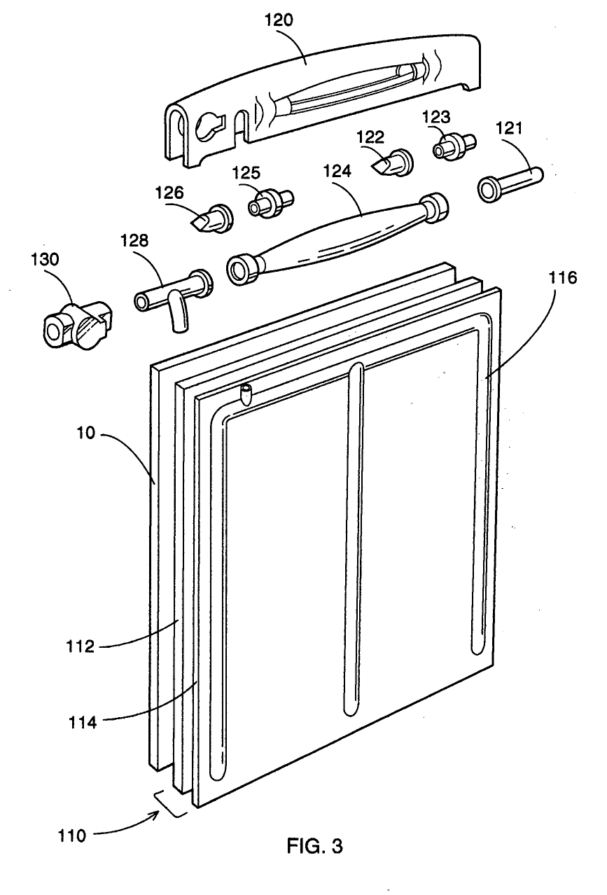

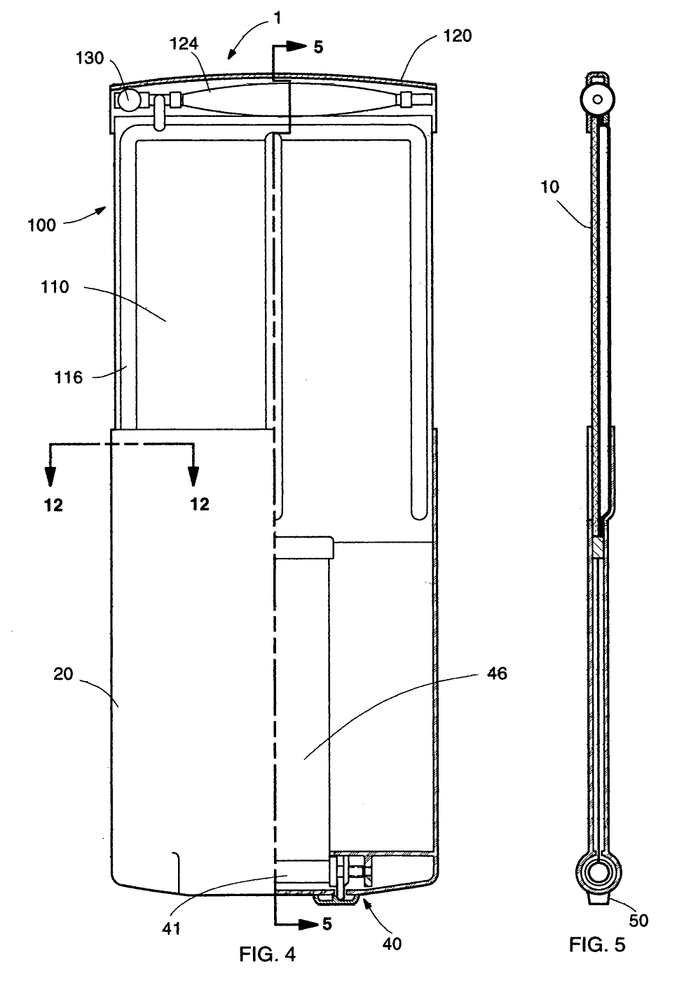

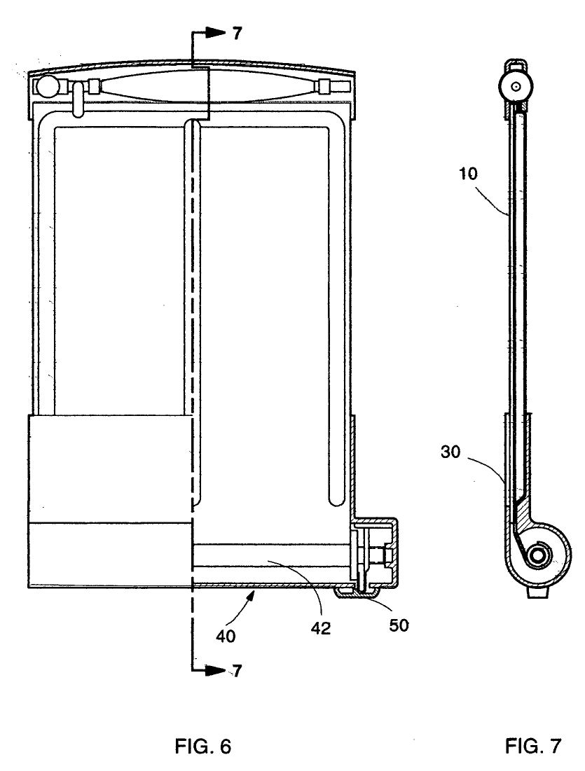

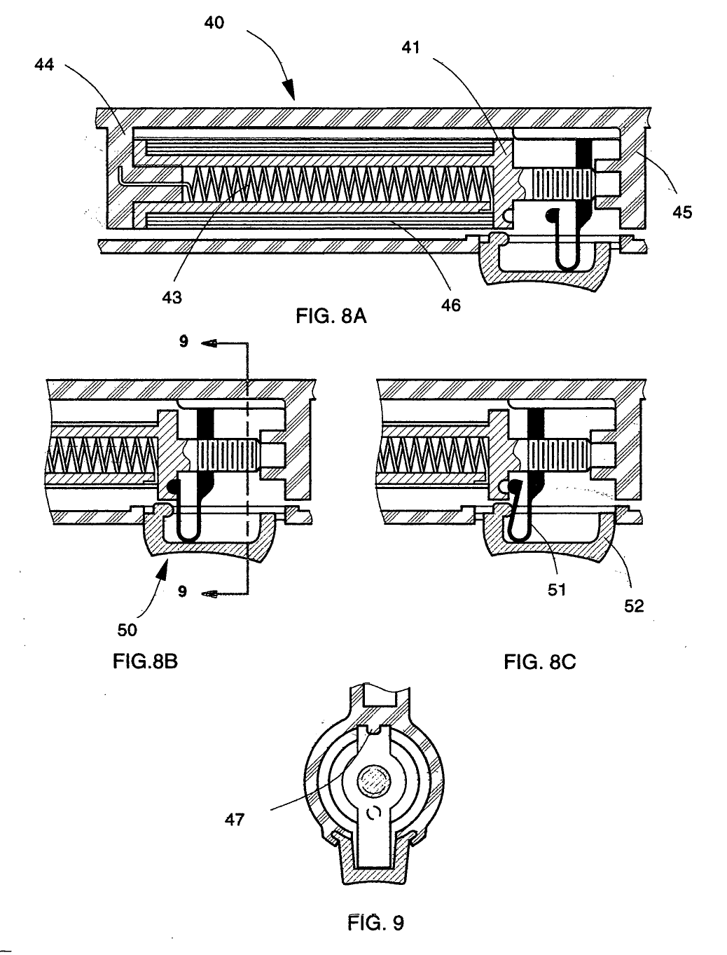

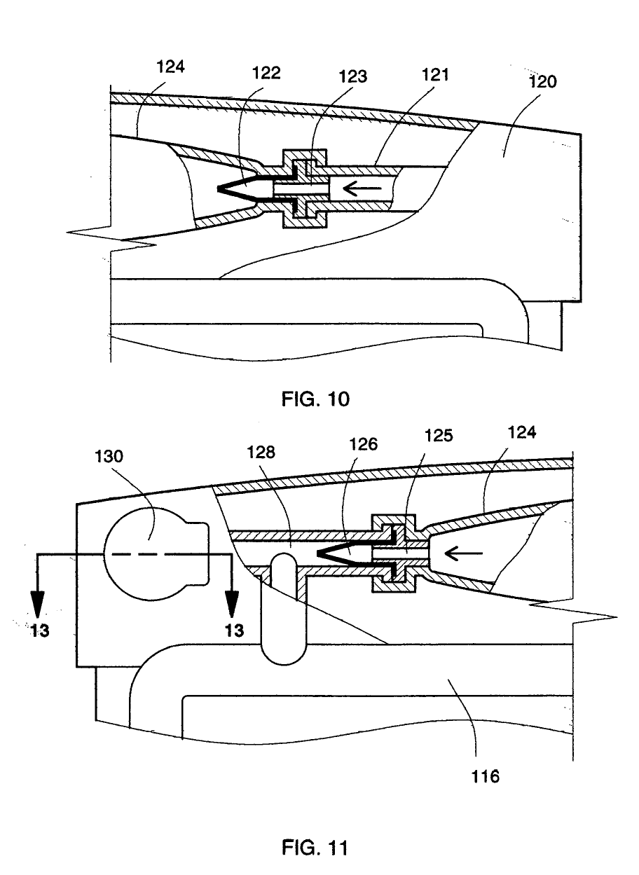

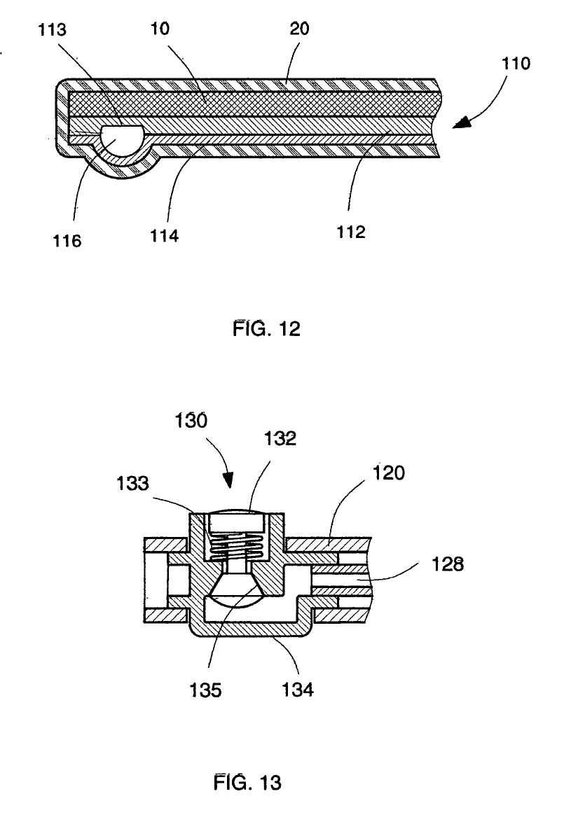

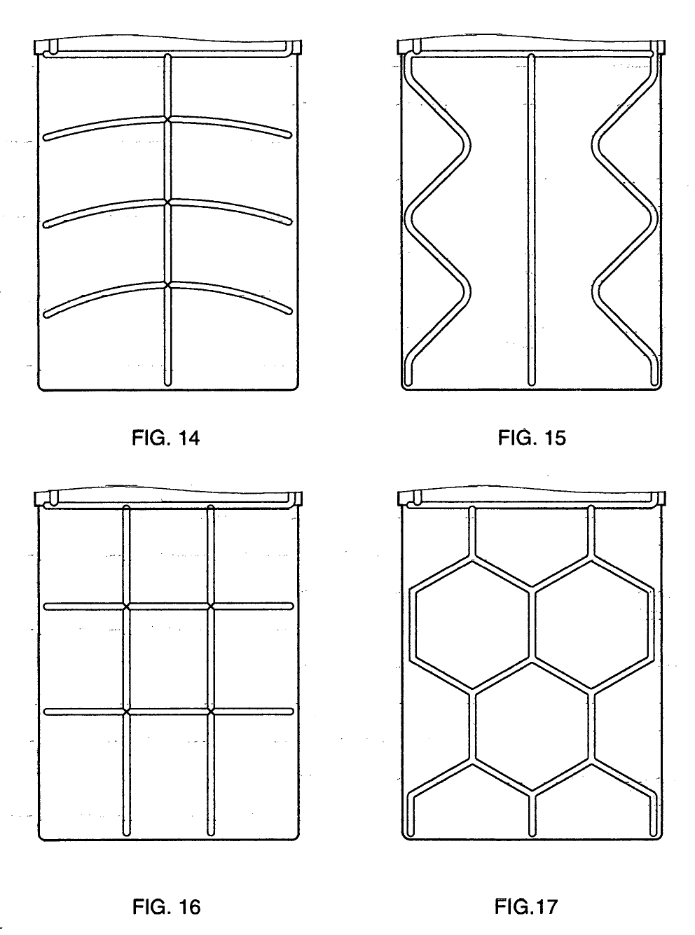

A preferred embodiment of the variable stiffness screen of the present invention is illustrated in FIGS. 1 and 2 (overall perspective view), FIG. 3 (exploded view), FIG. 4 (rear view), FIG. 5 (sectional view), FIG. 6 (rear view), FIG. 7 (sectional view), FIG. 8A (sectional view of a detail), FIG. 8B (sectional view of a detail), FIG. 8C (sectional view of a detail), FIG. 9 (sectional view of a detail), FIG. 10 (enlarged view of the upper part), FIG. 11 (enlarged view of the upper part), FIG. 12 (sectional view), FIG. 13 (sectional view), FIGS. 14, 15, 16, 17 (conduit patterns). The variable stiffness screen 1 incorporates a flexible display 10 attached to a pneumatic support system 100 with a handle 120 mounted on top of the screen (FIGS. 1 and 2). The screen 1 is encased in a carrying member, either a flexible flat sleeve 20 or a rigid case 30.

The sleeve 20 functions as a casing jacket that protects the flexible display 10 (FIGS. 1, 4 and 5), and it also has an embedded connecting and controlling circuitry. The sleeve 20 has a rectangular opening 21 at the top to accommodate the display's 10 permanent viewable area. The screen's pullback winding mechanism 40 (FIGS. 6 and 8A) is mounted inside at the bottom of the sleeve 20. The sleeve 20 is made from plastic, for instance silicon rubber, having a desirable combination of structural, electrical and tactile properties.

The case 30 houses the variable stiffness screen 10 (FIGS. 2, 6 and 7) and provides its connecting and controlling circuitry. The case 30 comprises a flat part 31 with a rectangular opening 32 revealing the display 10, and a cylindrical enclosure 33 carrying a winding mechanism 40 with a rolled-up part of the screen 1. The case 30 is made from a suitable rigid plastic.

The screen 1 functions in two working modes: closed and open. In a closed mode the screen 1 is pliable and placed inside the carrying member (FIGS. 1 and 2). The screen's upper part is exposed through the opening 21 in the carrying member thus creating the display's permanent viewable area. It allows for using the screen 1, while it is folded or bent, when the volume of visual information is relatively low. In this mode a deactivated support system 100 is hidden inside the carrying member, therefore structurally the screen 1 remains practically the same for all the embodiments.

In an open mode the screen 1 is pulled out of the carrying member 20/30 and its entire viewable area can be used to display a high volume of visual information (FIGS. 1 and 2). An activated support system provides the necessary rigidity for the screen in this drawn-out position. The specifics of each embodiment are most clearly evidenced in the working mode (FIGS. 4, 6, 18, 21, 23, 28). The screen 1 returns to the closed mode by means of the winding mechanism 40, when the support system 100 is deactivated.

The winding mechanism 40 consists of a cylindrical drum 41 supported from both ends, and a coil spring 43 housed inside the drum along its axis (FIG. 8A). One end of the coil spring is attached to the inner wall of the drum 41, and the other end is attached to the left support 44. As a result, the drum 41 is at all times urged by the spring 43 to wind the ribbon cable 46 attached to the flexible display 10, thus pulling it inside the carrying sleeve 20 (FIG. 8A).

The winding mechanism 40, which is used for the case 30, remains essentially the same as the one installed in the sleeve 20, except for the extended length of the drum 42 to accommodate the width of the screen 10 (FIG. 6). The screen 10 is wound into a roll on the drum 42 with one end attached to it. The drum 42 is mounted between the opposite walls of the case 30 for rotation about the longitudinal axis of the drum (FIG. 6). It contains a corresponding spring inside, similar to the spring 43.

When the flexible display 10 is being pulled out, the latch mechanism 50 secures it in an open position. The latch mechanism 50 includes a spring-loaded detent 51 and a slide-button 52. Normally, the detent 51 is positioned at the right end of the cylindrical drum 41 threaded shaft, next to the right support 45 (FIG. 8A). The detent 51 is supported by a guide member 47 providing its linear movement. When the display 10 is being pulled out, the detent 51, being driven by the revolving shaft, simultaneously moves along the guide member 47 (FIG. 9), until it engages the corresponding depression in the cylindrical drum 41 (FIG. 8B). At that moment the display 10 is completely pulled out and locked in this position. It securely remains there until the user pushes the slide-button 52 to the right, thus disengaging the detent 51 (FIG. 8C). It allows for the winding mechanism 40 to pull the flexible display 10 into the carrying member 20/30. At the same time the detent 51 moves back to its starting position.

The pneumatic support system 100 provides the desirable transfer from flexibility to firmness to the display 10 depending on the pressure applied to the air inside the system's structural elements. It allows the flexible display 10 to be normally pliable and placed inside either the sleeve 20 or case 30, and when the support system is actuated, to be firm and rigid for having a drawn-out working position (FIGS. 1, 2, 4, 6).

Structurally the pneumatic support system 100 comprises a flexible portion 110 and a rigid portion, the handle 120 (FIG. 3).

The flexible portion 110 is composed of two pieces, the inner sheet 112 and the outer sheet 114 (FIG. 12) of air-impervious elastomer, preferably urethane. Other similar lightweight, air-impervious, inflatable materials could readily be utilized. The inner sheet 112 is formed with a plurality of shallow grooves 113 serving as bottom portions of the screen's air inflatable interior chambers (FIG. 12). Being bonded together in a predetermined manner, both pieces create a plurality of air inflatable interior chambers, or the supporting conduits 116. The supporting conduits 116 communicate with each other and are heat-sealed along their perimeters.

The pattern and number of supporting conduits can vary depending on the structural properties of a particular flexible display. The less firm and resilient a display is, the denser pattern of the supporting conduits should be used. For instance, the conduits configuration with one central vertical element and a few additional elements provides quick inflation of the conduits (FIGS. 14 and 15). The wafer and honeycomb configurations of the conduits allow distributing support of the display structurally evenly, thus providing a sufficient level of the screen's stiffness in its withdrawn mode (FIGS. 16 and 17).

The handle 120 carries functional elements of the system: an air pump 124, an intake check valve 122, an outlet check valve 126 and a release valve 130. The air pump 124 draws air through the intake tube 121, and communicates with the supporting conduits 116 through the connecting tube 128 (FIGS. 3, 4, 10 and 11).

The air pump 124 is a flexible, resilient ellipsoidal bulb. It is a one-piece element formed of a resilient elastomeric material such as rubber, natural or synthetic or a blend thereof. The pump 124 is placed at the center of the handle 120 to serve two functions—inflation of the support conduits 116 and pulling of the flexible display 10 out of the sleeve 20 (FIG. 4). The system's structural stability is achieved by sandwiching the upper part of the inflatable portion 110 with the pump and valves between two halves of the inverted U-shaped handle 120 (FIGS. 3 and 5).

The check valves allow airflow in either direction. The check valves 122 and 126 are axially aligned on the opposite ends of the pump 124 and can vary in design and configuration. For instance, a conventional duckbill check valve is used for this purpose in both cases (FIGS. 10 and 11). The valves 122 and 126 themselves are formed of elastomeric material, preferably silicone, with a tubular body tapered to a flat at its output end. Under normal conditions, each valve is such as to preclude the flow of air there through. When, however, a pressure differential is generated on opposite sides thereof through the depression or release of the bulb, the check valves will open for the flow of air in one direction, as shown by the arrow. The intake check valve 122 is oriented to allow for the suction of air from the atmosphere to the pump 124. The outlet check valve 126 is placed to allow for the air passage from the pump 124 to the conduits 116. Upon the cessation of pumping, the check valves will close to preclude further movement of air there through. The valves are equipped with the corresponding adaptors 123 and 125 allowing for the proper attachment of the valves to the pump. The adaptors are preferably fabricated of a rigid material, aluminum, for instance, so that a secure coupling may be maintained.

The release valve 130 comprises a spring-loaded plunger 132 mounted in a fitting 134 having conically shaped aperture 135 (FIG. 13). The plunger's conical part mates to the aperture being urged inward by the coil spring 133. Therefore the release valve 130 is normally closed, precluding the loss of air from the conduits 116 through the aperture 135 into the atmosphere.

The operating state of the variable stiffness screen 1 of the present embodiment will now be explained. In order to withdraw the screen 1 the user grasps the screen's handle 120 and pulls the screen 1 from the carrying member against the action of the winding mechanism 30. When the display 10 is fully opened the user actuates the pneumatic support system 100 by depressing the pump 124.

Normally the proposed combination of the check and release valves does not allow for the flow of air through the system. To actuate the system the user starts depressing and releasing the pump 124. When the pump 124 is depressed (for example, by squeezing the bulb with the thumb and index finger), the air volume inside the bulb decreases, thus raising the pressure inside. It forces the outlet check valve 126 to open and the excess air is pumped into the conduits 116. When the manual pressure on the bulb is reduced, it returns to its original position, the intake check valve 122 opens and the pump 124 is filled with air. This cycle is repeated until the conduits 116 are fully inflated with air. To make inflating more efficient, the bulb can be reinforced with a plate spring or the like.

After being inflated, the conduits 116 are expanded to serve as a support structure for the display. Consequently, the entire screen 1 becomes firm and rigid for displaying the desirable amount of visual information. At the same time it becomes substantially thicker than its carrying member, and it precludes the screen 1 from being pulled back by the urging means of the winding mechanism 40.

Using the release valve 130 deflates the system. The user depresses the plunger 132 against the action of coil spring 133, thus connecting the inflated conduits 116 through the connecting tube 128 with the aperture 135. As a result, the excess air volume from the system escapes through the aperture 135 (FIG. 13). The system's air pressure equalizes to the atmospheric pressure, and the screen 1 becomes pliable enough t be pulled back automatically by the winding mechanism 40 (FIG. 5).

In an alternative embodiment of the pneumatic system, the air source may be a disposable gas cartridge (for instance, an O₂ source) that contains a certain number of filling charges for inflating the conduits.

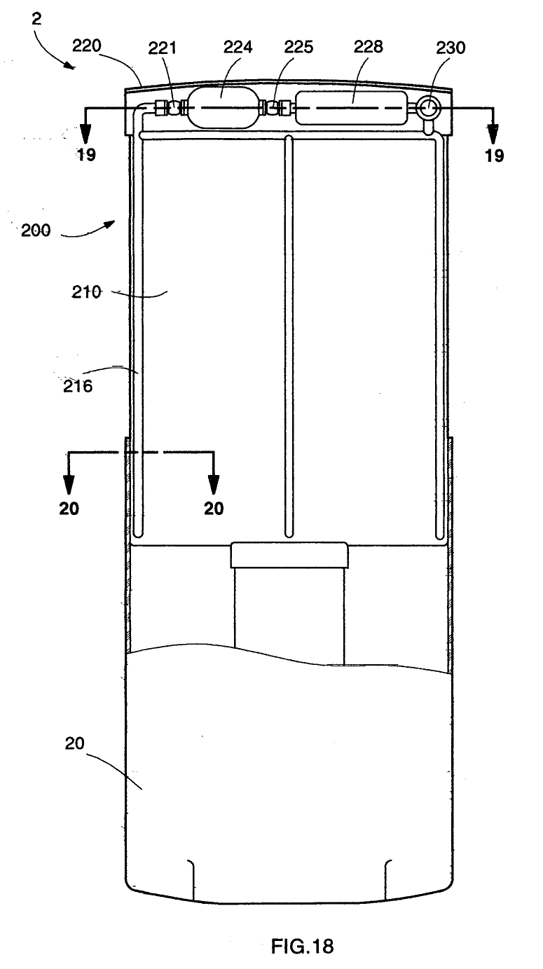

### Additional Embodiment: Variable Stiffness Screen with Hydraulic Support System, FIGS. 18-20

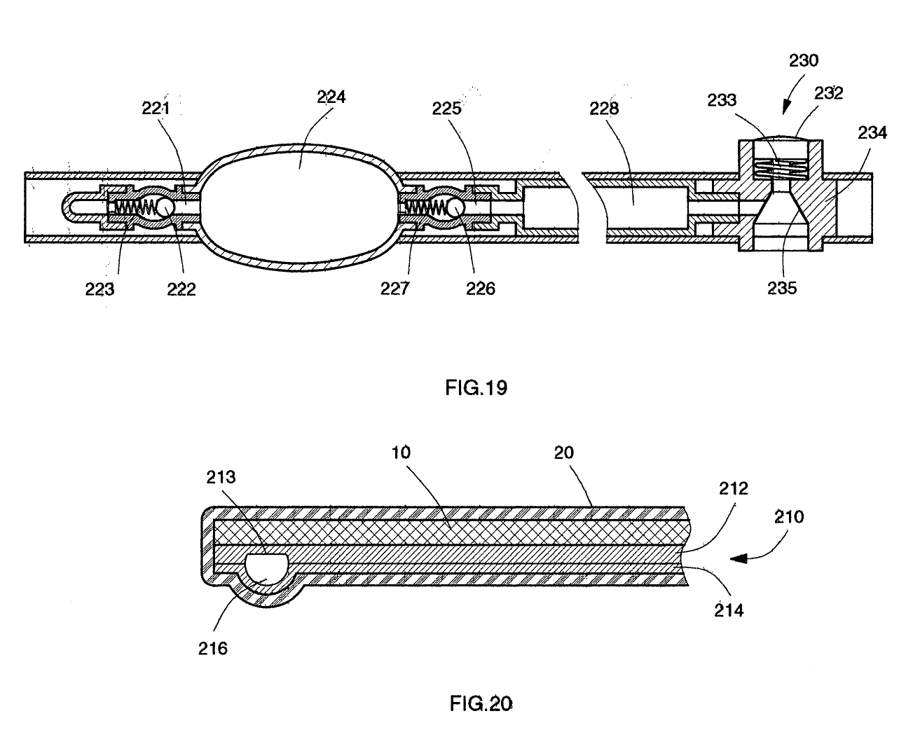

An additional embodiment of the variable stiffness screen of the present invention is illustrated in FIG. 18 (rear view), FIG. 19 (enlarged sectional view), FIG. 20 (sectional view of a detail). The variable stiffness screen 2 comprises the flexible display 10 attached to a hydraulic structural support system 200 with a handle 220 mounted at the top of the screen (FIG. 18). Similarly to the preferred embodiment, the screen 2 can be encased in a carrying member, either a sleeve 20 or a case 30 (FIGS. 1 and 2).

The hydraulic structural support system 200 is comprised of a flexible portion 210 with embedded conduits 216, and a rigid portion, the handle 220 (FIG. 18). Unlike the pneumatic system, the agent responsible for changing the screen's physical properties is hydraulic fluid, for instance mineral oil, instead of air.

The flexible portion 210 is composed of two pieces, the inner sheet 212 and the outer sheet 214 (FIG. 20) of fluid-impervious elastomer, preferably urethane. Other similar lightweight, fluid-impervious materials could readily be utilized. The inner sheet 212 is formed with a plurality of shallow grooves 213 serving as bottom portions of the screen's interior chambers. Being bonded together in a predetermined manner, both pieces create fluid filled interior chambers, or the supporting conduits 216. The supporting conduits 216 communicate with each other and are heat-sealed along their perimeters. The pattern and number of supporting conduits can vary depending on the structural properties of a particular flexible display.

The handle 220 carries functional elements of the system: a bulb pump 224 communicating with intake and outlet check valves, a hydraulic fluid tank 228, and a drain valve 230. The bulb pump 224 is situated next to the hydraulic fluid tank 228. They both are positioned towards the center of the handle 220 in such a way, as to combine actuation of the pump 224, along with pulling of the screen 2. The check valves 221 and 225 are axially aligned on the opposite ends of the pump 224 and can vary in design and configuration (FIGS. 18 and 19).

The check valves allow the flow of fluids in either direction. The intake check valve 221 is oriented in such a way, as to allow for the pumping of hydraulic fluid from the fluid tank 228 to the pump 224. The outlet check valve 221 is placed to allow for the passage of hydraulic fluid from the pump 224 to the conduits 216. An identical ball check valve is used for this purpose in both cases (FIG. 19). For instance, the intake check valve 225 has an essentially rigid ball 226 as its valve member that is seated against a valve seat of the corresponding cylindrical aperture. The ball 226 is resiliently biased to a normally closed position by a coil spring 227.

The drain valve 230 comprises a spring-loaded plunger 232 mounted in a fitting 234 having a conically shaped aperture 235. The plunger's conical part mates to the aperture being urged inward by the coil spring 233. Therefore the drain valve 230 is normally closed precluding the loss of hydraulic fluid from the conduits 216 through the aperture 235 into the tank 228 (FIG. 19).

When the bulb is squeezed, the volume inside the pump 224 decreases, thus raising the pressure inside. It forces the fluid from the pump to escape into the conduits 216 through the outlet valve 221. When the manual pressure on the bulb is reduced, it reverts to its original position, the intake valve 225 opens and the pump 224 is filled with fluid from the tank 228. During this cycle the drain valve 230 remains closed.

After being filled with hydraulic fluid, the conduits 216 are expanded to serve as a support structure for the display 10. Consequently, the entire screen 2 becomes rigid for displaying the desirable amount of visual information. At the same time it becomes substantially thicker than its carrying member, and it precludes the screen 2 from being pulled back by the urging means of the winding mechanism.

When the drain valve 230 is depressed and the fluid fills the tank 228, the display 10 becomes pliable enough to be stored, thus occupying minimal designated space. Therefore the system in configured in such a way to make the screen 2 either rigid or pliable by distributing a constant amount of hydraulic fluid between the conduits 216 and the tank 228.

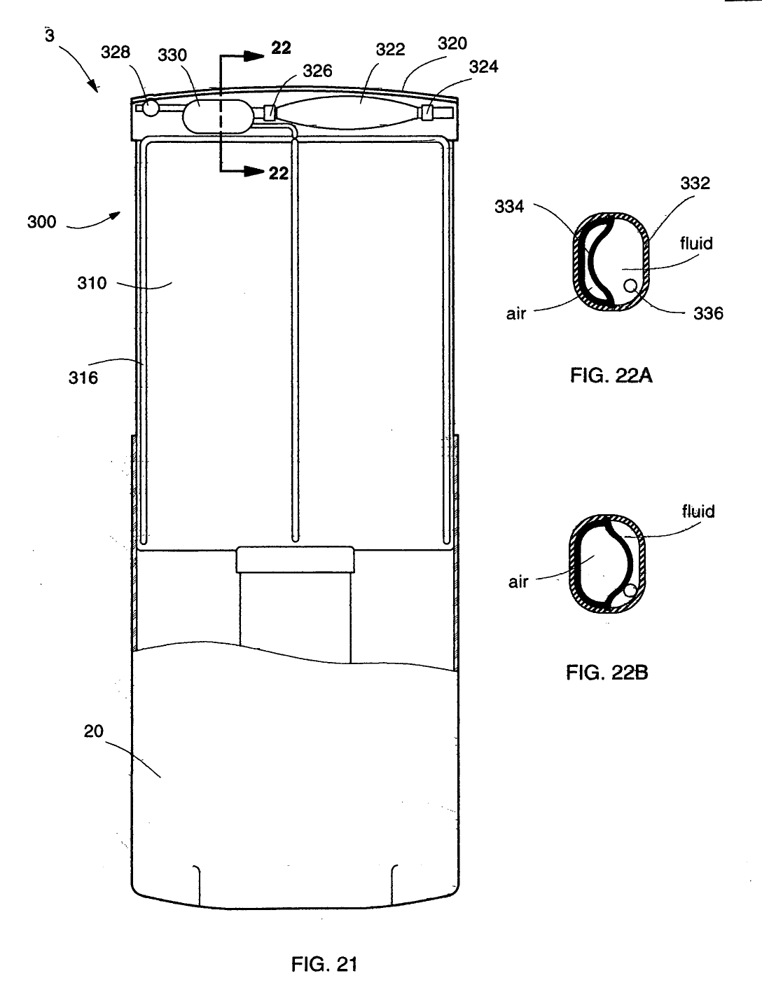

### Second Additional Embodiment: Variable Stiffness Screen with Hydropneumatic Support System, FIGS. 21, 22A, 22B

An additional embodiment of the variable stiffness screen of the present invention is illustrated in FIG. 21 (rear view), FIG. 22A (sectional view of a detail), FIG. 22B (sectional view of a detail). The variable stiffness screen 3 comprises the flexible display 10 attached to a hydropneumatic support system 300 with a handle 320 mounted at the top of the screen (FIG. 21). Similarly to the preferred embodiment, the screen 3 can be encased in a carrying member, either a sleeve 20 or a case 30 (FIGS. 1 and 2).

This system takes advantage of the fact that gas is a compressible substance unlike fluid. The hydropneumatic support system 300 has two components, the pneumatic and the hydraulic, organized in two separate loops. The pneumatic component operates the system by applying air pressure to hydraulic fluid by a means of an air pump 322 with intake 324 and outlet 326 check valves, and a hydropneumatic tank 330 (FIG. 21). The check valves are placed at the pump's opposite ends and can vary in design and configuration.

The tank 330 is mounted to the handle next to the pump 322, and consists of a rigid shell 332 and a flexible, resilient bladder 334 conforming to the left half of the shell (FIGS. 22A and 22B). The bladder 334 is secured in a special groove encircling the tank, thus creating a membrane-like element dividing the tank into two separate halves. The bladder is connected to the pump through the outlet check valve 326. The cavity outside the bladder is normally filled with hydraulic fluid, which is communicated to the conduits 316 through an orifice 336 (FIG. 22A).

When the pump 322 is actuated, it forces air to charge the bladder and apply pressure to the membrane, thus deforming it and, correspondingly, reducing the fluid volume. It expels the excess fluid from the tank 330 into the conduits 316 (FIG. 22B). Accordingly, it creates positive internal pressure in conduits, in turn making the flexible display 10 rigid and stable, while maintaining this current state through the working cession. When the release valve 328 is pressed, and the bladder's air pressure equalizes to the atmospheric pressure, the fluid from the conduits 316 returns to the tank 330. The original equilibrium is restored and the display 10 becomes pliable enough to be stored, thus occupying its designated space.

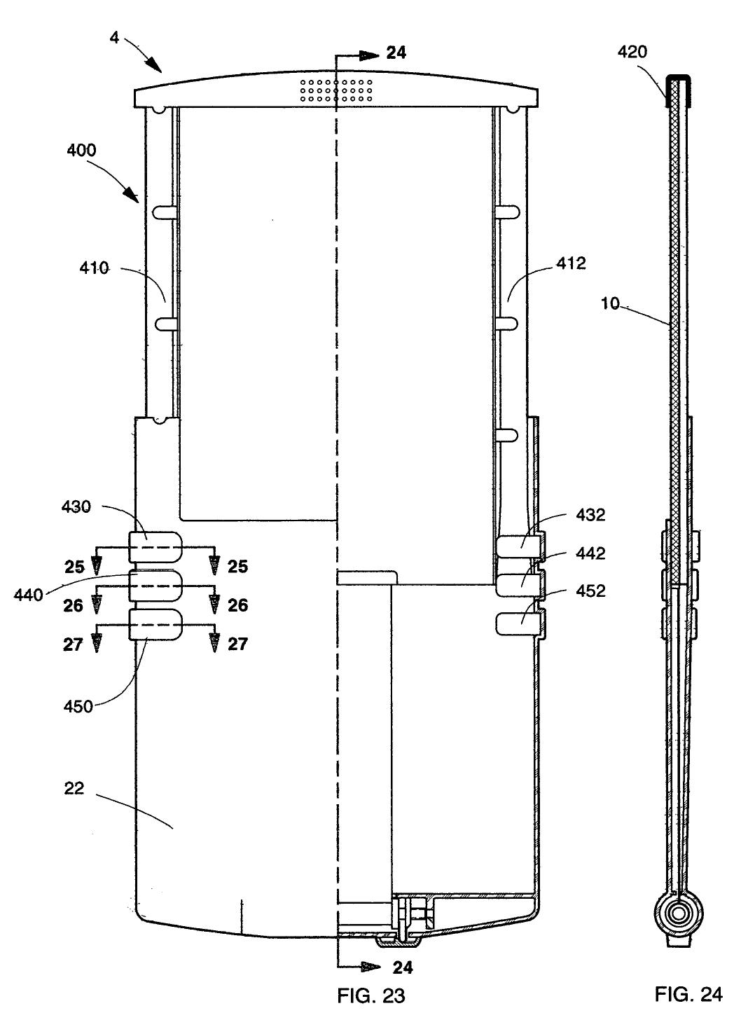

### Alternative Embodiment: Variable Stiffness Screen with Linear Support System, FIGS. 23-27

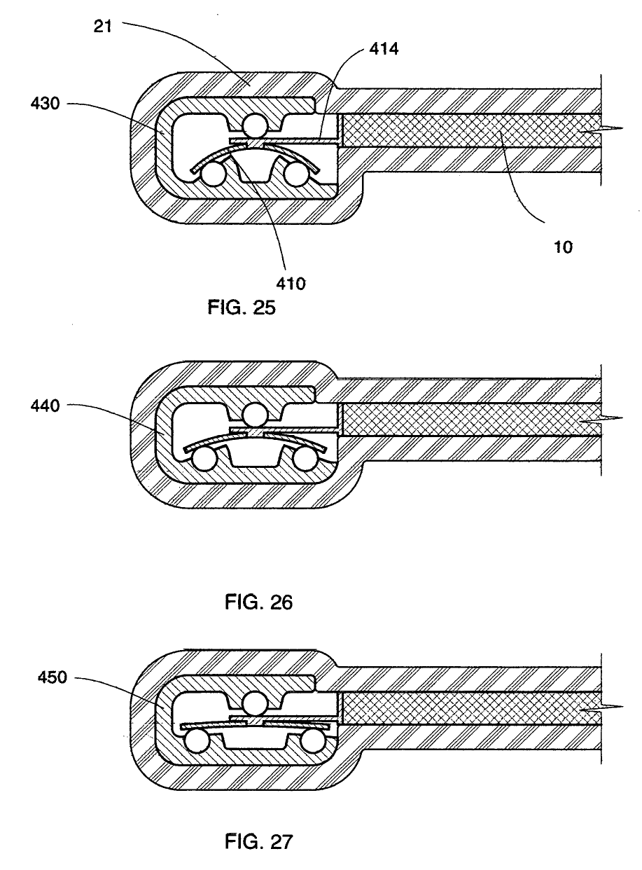

An alternative embodiment of the variable stiffness screen of the present invention is illustrated in FIG. 23 (front view), FIG. 24 (sectional view), FIG. 25 (sectional view of a detail), FIG. 26 (sectional view of a detail), FIG. 27 (sectional view of a detail), The variable stiffness screen 4 comprises the flexible display 10 attached to a flexible frame support system 400 with a handle 420 mounted at the top of the screen (FIG. 23). The screen 4 is encased in its carrying sleeve 22, which functions also as a part of the supporting system 400 (FIGS. 1 and 23).

The linear support system 400 is a combination of two identical linear members 410 and 412, attached symmetrically to both sides of the flexible display 10, and the corresponding shape-changing gates 430/432, 440/442, 450/452, belonging to the carrying sleeve 22. The handle 420 is attached to the linear members 410 and 412, thus creating a system (FIG. 23).

In the open mode (FIGS. 23 and 24) the linear members 410 and 412 have arcuate cross-sectional configurations, and they flatten, when stored inside the sleeve 22. The arcuate cross-sections provide the extended linear members 410/412 with rigidity and maintain them essentially straight in the longitudinal direction. The linear members 410/412 are flattened, when pulled through the shape-changing gates 430/432, 440/442 and 450/452 (FIG. 23). Simultaneously, the structure of each member is changing from rigid to flexible. This structural transformation allows the flexible display 10 to be rigid in its pulled-out position and pliable in its slide-in configuration.

The linear member 410/412 is constructed of a sheet metal ribbon that is shaped during manufacturing to have a normal or memory configuration that has a generally arcuate transverse cross-section (FIG. 25). Alternatively, the linear member 410/412 can be manufactured from extruded plastic with physical properties similar to those of steel.

The shape-changing gates 430, 440, 450 are placed on the left side and the gates 432, 442, 452—on the right side of the flexible display sleeve 22 in a consecutive order along the direction of the display's 10 movement (FIG. 23). Each gate holds three hardened steel balls arranged in a triangular layout, where the distances between the balls are specific to each gate (FIGS. 25, 26 and 27). The distance between the upper ball and lower two balls decreases from the upper gate 430 to the middle gate 440, and then even farther to the lower gate 450. At the same time the distance between the lower two balls is increasing from the gate 430 to the gate 450. This gradually changing configuration is necessary for creating vertical forces applied to the linear member 410 at the most appropriate places. The upper ball's central position allows for the lower balls to push the linear member's edges upward against the upper ball, thus gradually flattening the linear member 410, while the flexible display 10 is being pulled through the gates. The flexible display 10 is attached to the linear members 410 by a means of the bracket 414 (FIG. 25).

When the flexible display 10 is being pulled out, the winding mechanism's latch 50 secures it in an open position. (FIG. 8B) It remains there until the user pushes the slide-button 52 to the right, thus disengaging the detent 51 (FIG. 5C). It allows for the winding mechanism 30 to pull the flexible display 10 into the carrying sleeve 22.

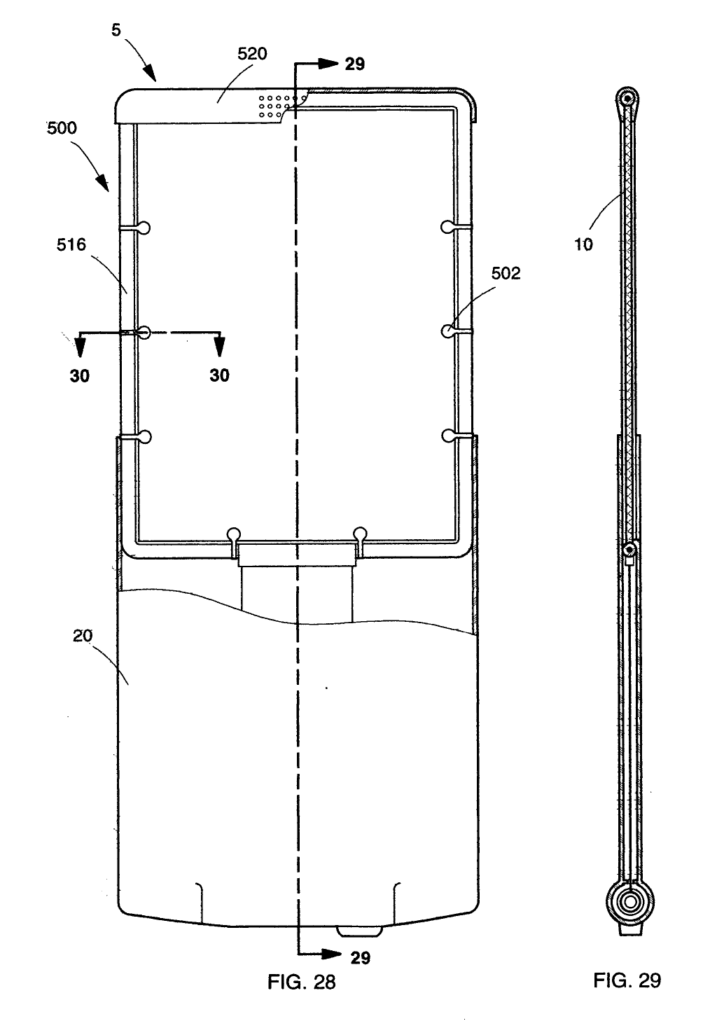

### Second Alternative Embodiment: Variable Stiffness Screen with Superelastic Support System. FIGS. 28-31

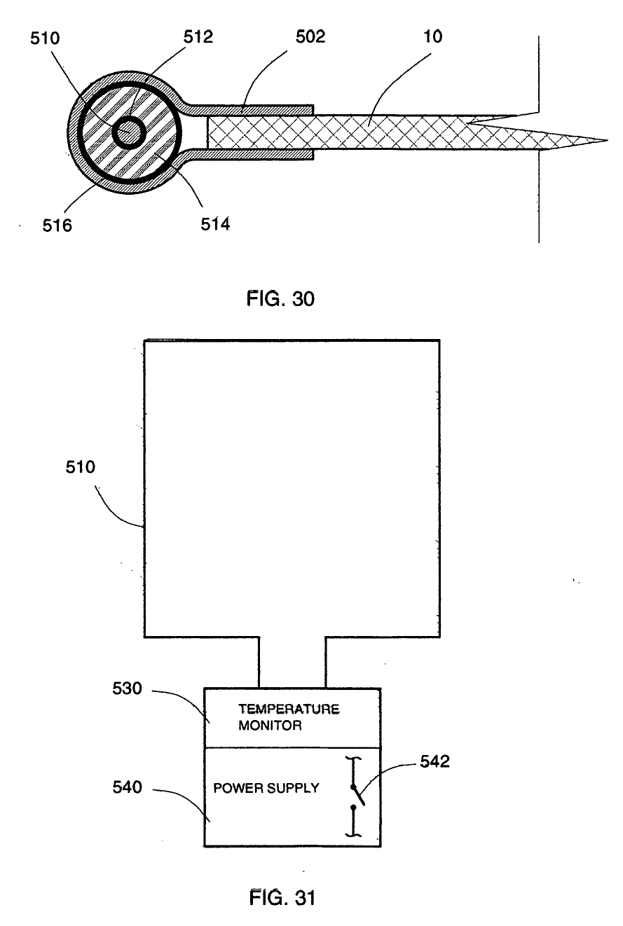

An alternative embodiment of the variable stiffness screen of the present invention is illustrated in FIG. 28 (front view), FIG. 29 (sectional view), FIG. 30 (enlarged sectional view of a detail), and FIG. 31 (schematic diagram of electrical circuitry). The variable stiffness screen 5 comprises the flexible display 10 attached to a structural support system 500 formed of a temperature activated metal alloy. A handle 520 is mounted at the top of the screen (FIGS. 28 and 29). Similarly to the preferred embodiment, the screen 5 can be encased in a carrying member, either a sleeve 20 or a case 30.

The superelastic support system is based on the unique ability of shape memory alloys, such as nickel titanium (Nitinol) to return to a predetermined shape when heated. When Nitinol is below its transformation temperature (Martensite crystal structure), it has very low yield strength and can be deformed rather easily. However, when the material is heated above its transformation temperature it undergoes a change in crystal structure, coming from Martensite to Austenite, which causes it to return to its original shape. Thus, if a frame, in our instance, is formed from Nitinol, when it is above its transformation temperature, it will “remember” its original shape and recover it when heated to that temperature.

The superelastic support system 500 is built around a Nitinol core wire 510 that is bent, when heated to the austenite state, in such a way that it creates a rectangular frame-like structure (FIG. 28). When the source of heat is removed, the frame becomes quite pliable at its “normal”, below the transformation, temperature. It allows for it to be stored, while occupying minimal designated space.

The temperature variable superelastic Nitinol or other suitable superelastic alloy should have a Young's modulus ranging from 4×10⁶ to 14×10⁶ psi. The material has a Young's modulus in a soft martensitic state of 4-6×10⁶ psi and a stiff or austenitic state ranging from 10-14×10⁶ psi. The flexible display 10 is attached to the shape memory frame support system 500 by a means of an inverted U-shaped handle 520 and brackets 502 holding it a little apart from the structure (FIGS. 28 and 29).

The core wire 510 is coated with a suitable electrical insulating material, for example, a thin wall polyimide coating 512 having a thickness ranging from 0.0025″ to 0.004″ (FIG. 30). The core wire 510 is placed inside a flexible tubular sleeve 516, which can be formed of a suitable material such as polyethylene, polyimide or PET and having a thickness ranging from 0.004″ to 0.008″.

A polyimide coating has been selected in connection with the present invention, because it has a very high elastic strain compared to other conventional polymers. Polyimide is also a rather tough material. Since it is a cross-linked polymer, it has good adhesion characteristics to the metal alloy core wire. A suitable material such as foamed silicone 514 placed between the wire coating 512 and the tubular sleeve 516 provides the necessary heat insulation (FIG. 30). The foamed insulating material is desirable, because while providing heat insulation, it is very light and flexible, thereby permitting bending of the core wire.

The core wire 510 is connected to a power supply 540 through a temperature monitor 530 that provides an optimal electrical current depending on the desirable Nitinol's crystal structure, as well as the environment's temperature. An on/off switch 542 is part of the power supply 540, as it is shown on the schematic diagram of electrical circuitry (FIG. 31).

After pulling out the flexible display 10, the user actuates the superelastic support system 500 by switching it “on”. Instantly electrical energy is supplied to the Nitinol core wire 510 to heat the same above its transformation temperature, changing its crystal structure to the austenitic state. In turn it forces the wire to retake its preformed rigid frame-like shape, correspondingly making the attached display 10 rigid and stable, while maintaining it so through the working cession. When the switch is in the “off” position the heat is removed and the superelastic support system 500 becomes flexible enough to be pulled back automatically by a means of the winding mechanism 430 mounted at the sleeve's 20 bottom.

### CONCLUSION, RAMIFICATIONS, AND SCOPE

Accordingly, the reader will see that the variable stiffness screen's functional flexibility allows to create a desirable visual interface between the user and a wearable digital device, providing viewing ability of high-quality graphics and images comparable in the viewable size to that of a handheld's display, or even larger. This level of presentation of information is not achievable on cellular phones and wrist-worn devices by the existing means.

The screen's immediate accessibility and adjustability define the proposed invention. By providing the proposed flexible video interface it could transform the existing archetypes of wearable electronic devices into user-centered products that can adjust themselves rapidly to different requirements.

The proposed structural system in all of its embodiments allows for the variable stiffness screen to be used as a universal interface platform for the new generation of cellular phones and wireless terminals/PDA. It allows to fully utilize the great potential of the flexible display technology, regardless of a particular flexible display chosen by the manufacturer.

We claim:

1. A variable stiffness screen comprising a flexible electronic display attached to a structural system providing means for changing said screen stiffness from flexibility to rigidity to make said display stiff and stable.

2. The screen of claim 1, further including a carrying member encasing said screen; wherein said screen functions in a closed position inside said carrying member and in an open position, where said display is fully visible to a user.

3. The screen of claim 2, wherein said screen is coupled to said carrying member by means of a pullback winding mechanism, which includes locking means allowing to secure said screen in said open position.

4. The screen of claim 3, wherein said locking means comprising a spring-loaded detent driven by a threaded shaft and supported by a corresponding guide member providing a linear movement of said detent.

5. The screen of claim 2, wherein said carrying member is a flexible flat sleeve having a rectangular opening revealing a respective part of said display, and incorporating an embedded electrical circuitry.

6. The screen of claim 2, wherein said carrying member is a rigid case comprising a flat part with said rectangular opening and an adjacent cylindrical enclosure housing a rolled-up part of said screen, and said case includes said embedded electrical circuitry.

7. The screen of claim 1, wherein said means for changing said screen stiffness from flexibility to rigidity include a fluid-based structural support system.

8. The screen of claim 7, wherein said fluid-based structural support system comprising a flexible portion and a rigid portion.

9. The screen of claim 8, wherein said flexible portion is formed of two bonded together air-impervious pieces in such a way as to create a plurality of sealed interior chambers.

10. The screen of claim 8, wherein said rigid portion includes means for inflating said interior chambers.

11. The screen of claim 10, wherein said means for inflating said interior chambers include a pneumatic pump associated with check and release valves, all interrelated with each other and said interior chambers.

12. The screen of claim 8, wherein said flexible portion is formed of two bonded together fluid-impervious pieces in such a way as to create a plurality of sealed interior chambers filled with hydraulic fluid.

13. The screen of claim 8, wherein said rigid portion includes means for operating said hydraulic fluid.

14. The screen of claim 13, wherein said means for operating said hydraulic fluid include a hydraulic pump along with a hydraulic fluid tank and associated check and drain valves, all interrelated with each other and said interior chambers.

15. The screen of claim 13, wherein said means for operating said hydraulic fluid include a pneumatic pump along with a hydropneumatic tank and associated check and release valves, all interrelated with each other.

16. The screen of claim 1, wherein said means for changing said screen stiffness from flexibility to rigidity comprising a combination of two linear members attached symmetrically to both sides of said display, and respectively, two pluralities of shape changing elements belonging to said carrying member.

17. The screen of claim 16, wherein said linear members have predetermined arcuate cross-sectional configuration.

18. The screen of claim 16, wherein said shape-changing element comprising a C-shape bracket holding three spherical members organized in a substantially triangular configuration.

19. The screen of claim 1, wherein said means for changing said screen stiffness from flexibility to rigidity comprising a frame-like structural member attached to said display, and said structural member stiffen when an electric charge is applied, and a power supply is connected to said structural member.

20. The screen of claim 19, wherein a core of said frame-like structural member being formed of a temperature activated metal alloy, which is normally flexible and becomes substantially rigid when it is heated above its transformation temperature, and the heating source is an electrical current.
